(19) United States
(12) Patent Application Publication
(10) Pub. No.: US 2016/0257830 A1
(43) Pub. Date: Sep. 8, 2016

(54) BIOPLASMONIC CALLIGRAPHY FOR LABEL-FREE BIODETECTION

(71) Applicant: Washington University in St. Louis, St. Louis, MO (US)

(72) Inventors: Srikanth Singamaneni, St. Louis, MO (US); Limei Tian, St. Louis, MO (US); Sirimuvva Tadepalli, St. Louis, MO (US); Jeremiah Morrissey, St. Louis, MO (US); Evan D. Kharasch, St. Louis, MO (US)

(21) Appl. No.: 15/059,570

(22) Filed: Mar. 3, 2016

Related U.S. Application Data
(60) Provisional application No. 62/127,525, filed on Mar. 3, 2015.

(51) Int. Cl. C09D 11/18; C09D 5/38; B43K 7/02; B05D 1/28

(52) U.S. Cl. CPC C09D 11/18; B05D 1/28; C09D 5/38; B43K 7/02

(57) ABSTRACT

The present disclosure relates generally to plasmonic calligraphy and, more specifically, to bioplasmonic calligraphy for label-free biodetection.

### CROSS-REFERENCE TO RELATED APPLICATIONS

This application claims the benefit to U.S. Provisional Application Ser. No. 62/127,523, filed Mar. 3, 2015, which is incorporated herein by reference in its entirety.

### STATEMENT REGARDING FEDERALLY SPONSORED RESEARCH & DEVELOPMENT

This invention was made with government support under grant CBET-1254399, awarded by the National Science Foundation, and grant NCIRO1CA141521, awarded by the National Institutes of Health and Air Force Research Laboratories. The Government has certain rights in the invention.

### BACKGROUND OF THE DISCLOSURE

The present disclosure relates generally to label-free detection and materials for label-free detection. More specifically, the present disclosure is directed to bioplasmonic calligraphy for multiplexed label-free biodetection.

Printable multi-marker biochips that enable simultaneous quantitative detection of multiple target biomarkers in point-of-care and resource-limited settings are desired in the field of biodiagnostics. However, preserving the functionality of biomolecules, which are routinely employed as recognition elements, during conventional printing approaches remains challenging.

Owing to numerous advantages such as high specific surface area, excellent wicking properties, compatibility with conventional printing approaches, significant cost reduction and easy disposability, paper substrates are gaining increased attention in, including, but not limited to, biodiagnostics, food quality testing, environmental monitoring, flexible energy and electronic devices. Recent surges in the activity related to paper-based diagnostic devices are primarily focused on realizing microfluidic paper-based analytical devices (mPADs) for point-of-care assays and inexpensive diagnostic tools for resource-limited environments. Most of these developments rely on labor-, time- and/or resource-intensive patterning techniques such as photolithography, wax, printing, and ink-jet printing of polydimethylsiloxane (PDMS), to create fluidic pathways and/or different functional regions for site-selective adsorption of the biochemical reagents. Moreover, implementing ink-jet printing with biomolecules can result in loss of recognition functionality due to the inherent temperature variations associated with ink-jet printing processes.

The refractive index sensitivity of localized surface plasmon resonance (LSPR) of plasmonic nanostructures renders it an attractive transduction platform for chemical and biological sensing.

These considerations highlight the need for a simple and biofriendly technique that enables multi-marker biochips for point-of-care and resource-limited settings.

### BRIEF DESCRIPTION OF THE DISCLOSURE

In aspect, the present disclosure is directed to a method of preparing a label-free biosensing substrate, the method comprising: providing a plasmonic ink dispensing apparatus, wherein the plasmonic ink dispensing apparatus comprises a plasmonic ink, the plasmonic ink comprising a plurality of metal nanostructures and a carrier matrix; and depositing the plasmonic ink on a substrate to produce a pattern on the substrate.

In another aspect, the present disclosure is directed to a plasmonic ink comprising: a plurality of metal nanostructures and a carrier matrix.

In another aspect, the present disclosure is directed to a plasmonic ink dispensing apparatus comprising: a ballpoint pen comprising: an ink-accommodation cylinder; a pen tip in which a ball is rotatably held, the pen tip being attached to a tip end of an ink-accommodation cylinder directly or through a tip holder; and a plasmonic ink comprising a plurality of metal nanostructures and a carrier matrix, the plasmonic ink directly being accommodated in the ink-accommodation cylinder.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure will be better understood, and features, aspects and advantages other than those set forth above will become apparent when consideration is given to the following detailed description thereof. Such detailed description makes reference to the following drawings, wherein:

FIG. 1A is an exemplary embodiment of a transmission electron micrograph image of AuNRs used as transducers in accordance with the present disclosure.

FIG. 1B is an exemplary embodiment of a plasmonic calligraphy on a paper substrate using AuNRs ink in accordance with the present disclosure.

FIG. 1C is an exemplary embodiment of an extinction spectra of AuNRs after absorption on paper at different locations showing a homogenous LSPR with a standard deviation of less than 1 nm in accordance with the present disclosure.

FIG. 1D is an exemplary embodiment of a representative LSPR spectrum of AuNRs from a paper substrate deconvoluted using two Gaussian peaks in accordance with the present disclosure.

FIG. 1E and FIG. 1F are exemplary embodiments of SEM images of AuNRs showing uniform absorption of AuNRs on paper substrates in accordance with the present disclosure.

FIG. 2A is an exemplary embodiment of an optical image showing AuNRs modified with positively charged poly(allylamine hydrochloride) (PAH@AuNR) written on a stem portion of the paper substrate in accordance with the present disclosure.

FIG. 2B is an exemplary embodiment of a fluorescence image showing model analyte solution comprised of negatively charged fluorescein molecules being absorbed at a lower stem portion of the paper substrate in accordance with the present disclosure.

FIG. 2C is an exemplary embodiment of an image showing the absorption on a paper substrate of negatively charged fluorescein molecules on positively charged PAH@AuNRs in accordance with the present disclosure.

FIG. 3A is an exemplary embodiment of an image showing a paper substrate with different size test domain areas in accordance with the present disclosure.

FIG. 3B is an exemplary embodiment of an extinction spectra of AuNRs on paper with a test domain size of 6 mm upon exposure to anti-IgG in accordance with the present disclosure.

FIG. 3C is an exemplary embodiment of an extinction spectra of AuNRs on paper with a test domain size of 3 mm upon exposure to anti-IgG in accordance with the present disclosure.

FIG. 3D is an exemplary embodiment of LSPR shifts for different test domain sizes in accordance with the present disclosure.

FIG. 4A is an exemplary embodiment of a schematic showing bioplasmonic calligraphy in accordance with the present disclosure.

FIG. 4B is an exemplary embodiment of a SEM image of AuNR-IgG conjugates absorption on paper substrates by bioplasmonic calligraphy in accordance with the present disclosure.

FIG. 4C is an exemplary embodiment of an extinction spectra of AuNRs-IgG conjugates on paper substrate before and after binding of anti-IgG in accordance with the present disclosure.

FIG. 4D is an exemplary embodiment of a LSPR peak shifts of bioplasmonic paper at various concentrations of anti-IgG and BSA in accordance with the present disclosure.

FIG. 5A is an exemplary embodiment of a schematic showing multiplexed detection based on bioplasmonic calligraphy in accordance with the present disclosure.

FIG. 5B is an exemplary embodiment of a longitudinal LSPR wavelength shifts of AuNRs functionalized with human and mouse IgG corresponding to exposure to calligraphed paper to goat anti-human IgG, goat anti-mouse IgG, and a mixture of both in accordance with the present disclosure.

FIG. 5C is an exemplary embodiment of longitudinal LSPR wavelength shifts of NR-human IgG and NR-mouse IgG corresponding to exposure to calligraphed paper to a mixture of different concentrations of goat anti-mouse IgG and a constant concentration of goat anti-human IgG in accordance with the present disclosure.

### DETAILED DESCRIPTION OF THE DISCLOSURE

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

The present disclosure is directed to a low-cost approach for fabricating multiplexed label-free biosensing on paper substrates in the form of bioplasmonic calligraphy. The calligraphy approach allows creation of well-isolated test domains on paper substrates using biofunctionalized plasmonic nanostructures as ink.

In one aspect, the present disclosure is directed to a method of preparing a label-free biosensing substrate. The method includes providing a plasmonic ink dispensing apparatus, wherein the plasmonic ink dispensing apparatus comprises a plasmonic ink, the plasmonic ink comprising a plurality of metal nanostructures and a carrier; and depositing the plasmonic ink on a substrate to produce a pattern on the substrate.

Suitably, the plurality of metal nanostructures comprises a plurality of biofunctionalized nanostructures. Particularly suitable biofunctionalized nanostructures include biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof. Suitable metals include gold, silver, and combinations thereof.

The metal nanostructures can further include a binding domain that specifically binds to a target biomolecule. Suitable binding domains include antibodies, aptamers, ligands, peptides, and nucleic acids.

Suitable substrates include paper substrates, cellulose substrates, and nylon substrates.

The method can further include providing at least a second plasmonic ink dispensing apparatus, the second plasmonic ink dispensing apparatus including a second plasmonic ink, the second plasmonic ink including a plurality of second metal nanostructures; and depositing the second plasmonic ink on the substrate to produce a second pattern on the substrate.

In other embodiments, the method can further include providing a third, a fourth, a fifth, etc. plasmonic ink dispensing apparatus each apparatus including a plurality of distinct (i.e., different) metal nanostructures; and depositing the plasmonic inks on the substrate to produce a third, a fourth, a fifth, etc. pattern on the substrate. Depositing inks having different metal nanostructures allows for multiplexing to detect multiple analytes in a sample using the same substrate.

The plasmonic inks can be deposited on the substrate manually. In other embodiments, the plasmonic inks can be deposited on the substrate in an automated manner

Plasmonic calligraphy involves a regular ball point pen filled with metal nanostructures, such as biofunctionalized gold nanorods in a carrier matrix as plasmonic ink, for creating isolated test domains on paper substrates. Biofriendly plasmonic calligraphy approaches serve as facile methods to miniaturize the test domain size to a few mm², which significantly improves the sensitivity of the plasmonic biosensor compared to bioplasmonic paper fabricated using immersion approaches. Furthermore, plasmonic calligraphy also serves as a simple and efficient way to isolate multiple test domains on a single test strip, which facilitates multiplexed biodetection and multi-marker biochips. Plasmonic calligraphy, which can also be automated by implementing with a robotic arm, serves as an alternate path forward to overcome the limitations of conventional ink-jet printing.

Plasmonic paper comprised of metal nanostructures uniformly adsorbs on paper substrates. The bioplasmonic paper enables the detection of target analytes such as biomarkers in analyte solutions such as biological samples. For example, bioplasmonic paper allows for the detection of aquaporin-1, a kidney cancer biomarker in artificial urine down to a concentration of 10 ng/ml. Bioplasmonic paper, fabricated by immersing a paper substrate into a biofunctionalized AuNRs solution, facilitates the detection of one specific target protein in the analyte solution (e.g., urine). This immersion approach hinders spatial multiplexing (i.e., realizing multiple test domains for the detection of more than one target biomolecule on the same substrate) as it results in uniform adsorption of the bioconjugated nanorods over the entire paper surface.

In some embodiments, a simple yet powerful plasmonic calligraphy approach for realizing multiplexed label-free bioassays using a regular ballpoint pen filled with metal nanostructures such as gold nanorods or biofunctionalized gold nanorods as (bio)plasmonic ink is described. In some embodiments, gold nanorods are used as plasmonic nano-transducers. Plasmonic calligraphy offers at least two distinct advantages over plasmonic paper substrates obtained by immersion method as mentioned previously. Firstly, plasmonic calligraphy serves as a facile method to miniaturize the test domain size to a few mm², which significantly improves the sensitivity of the plasmonic biosensor compared to bioplasmonic papers, fabricated using immersion approaches. Secondly, bioplasmonic calligraphy enables simple and efficient multiplexed biodetection on paper substrates thus leading to multi-marker biochips.

### I. Characterization of Plasmonic Calligraphed Paper

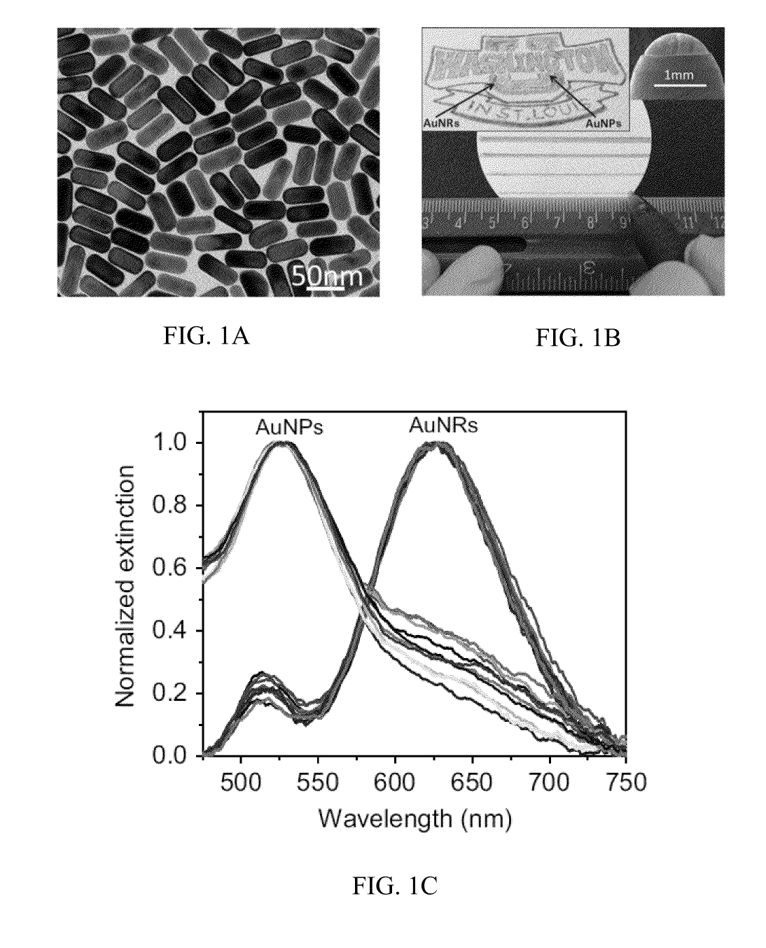

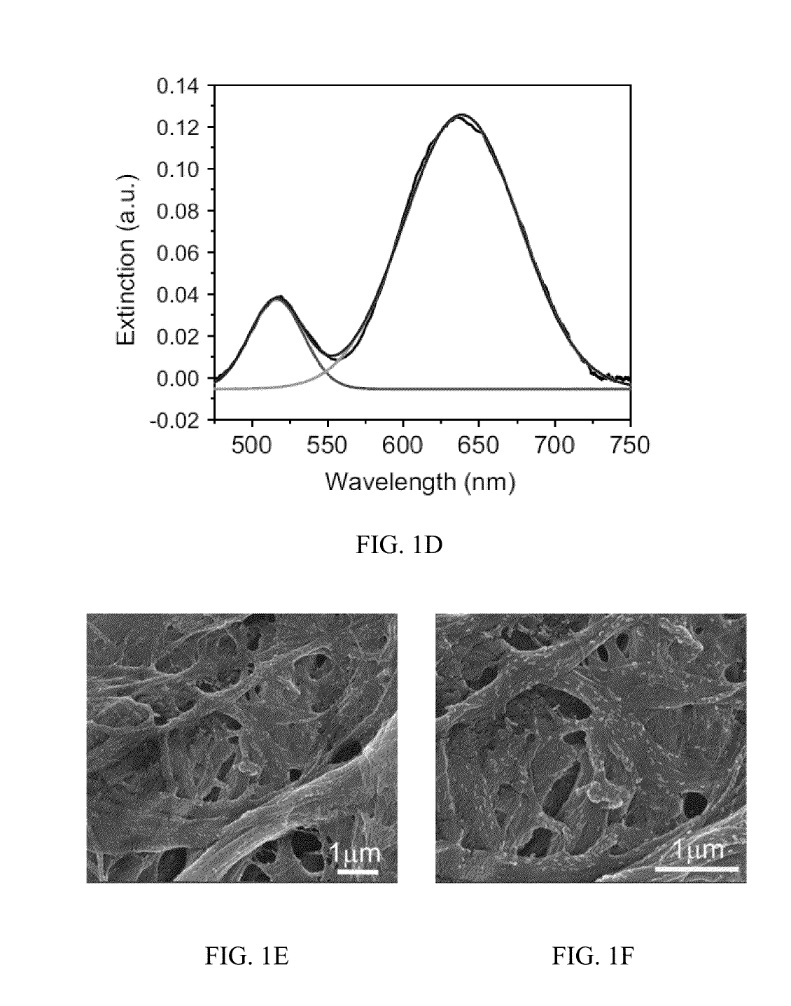

Plasmonic calligraphy using a plasmonic ink dispensing apparatus such as a ballpoint pen to form sensing islands on paper offers a unique advantage in that the volume of ink deposited can be well-controlled by altering the viscosity of the ink and ‘finesse’ of the ball used for writing. A more conventional approach of micropipette-based deposition of sensing elements (i.e., biofunctionalized AuNR) on paper surface results in fuzzy boundaries and non-uniform drying patterns due to uncontrolled evaporation on heterogeneous paper surface. Gold nanorods are particularly attractive as plasmonic transducers considering the high refractive index sensitivity of longitudinal LSPR, facile and large tunability of the LSPR wavelength with aspect ratio and the electromagnetic (EM) hot-spots at the tips. AuNRs, synthesized using a seed-mediated approach, are positively charged with a length of 56.3±3.7 nm and a diameter of 22.4±1.8 nm (FIG. 1A). FIG. 1B depicts plasmonic calligraphy on a laboratory filter paper using a regular ballpoint pen with plasmonic ink containing AuNRs (“AuNRs ink”), which yields continuous and clearly defined lines visible to even an un-aided eye. Ball pens are particularly well suited for dispensing plasmonic inks due to their compatibility with liquid and gels. The viscosity of AuNRs ink was measured to be ˜1.25Pa s, which is close to the optimal viscosity for certain embodiments of silver nanoparticle ink. The left inset image of FIG. 1B depicts a logo in a complex pattern, drawn on a laboratory filter paper using cetyltrimethylammonium chloride (CTAC) stabilized gold nanospheres (AuNPs) and cetyltrimethylammonium bromide (CTAB) stabilized gold nanorods (AuNRs). The right inset image of FIG. 1B depicts the SEM image of the tip of a ballpoint pen with a ball diameter of ˜1.5 mm, showing the residue of AuNRs ink left on the ball surface. Extinction spectra collected from several locations of both regions of the logo drawn with AuNPs and AuNRs ink revealed excellent optical uniformity of the plasmonic paper substrate (FIG. 1C). UV-vis extinction spectrum obtained from AuNRs region is characterized by two distinct bands corresponding to the transverse (lower wavelength) and longitudinal (higher wavelength) oscillation of electrons with the incident EM field (FIG. 1C).

The extinction spectrum of AuNRs was deconvoluted by fitting the extinction spectrum with two Gaussian peaks to obtain the longitudinal LSPR wavelength of AuNRs, which was used to monitor the binding of target proteins to AuNRs (FIG. 1D). Longitudinal LSPR of AuNRs is more sensitive to the refractive index change of the surrounding medium compared to its transverse band and LSPR of AuNPs. Longitudinal LSPR wavelength measured from ten different spots of the AuNRs region of the logo exhibited a small standard deviation of ˜1 nm (FIG. 1C). The spectral homogeneity is due to the uniform adsorption of AuNRs on paper substrates as evidenced by the SEM images (FIGS. 1E and 1F). The spectral homogeneity observed here is quite remarkable considering the simplicity of the writing process and the inherent heterogeneity of the paper substrates (large surface roughness and hierarchical nature of the fibrous mat). The density of the nanostructures on the paper substrate can be controlled by the number of strokes. The density of the AuNRs adsorbed on the paper substrate for a single stroke was found to be 31±9/μm² determined from SEM micrographs. Notably, the adsorption of AuNRs on paper is sufficiently strong to resist desorption from paper surface even after extensive rinsing with water or buffer as confirmed by little change in the intensity and shape of extinction spectra collected before and after rinsing. In addition to AuNRs, various shape-controlled nanostructures stabilized with different ligands, including gold nanospheres stabilized with citrate ions, gold nanoshells capped with poly(vinyl pyrrolidone) (PVP), can be written on paper with no sign of aggregation or patchiness.

### II. Significant Improvement on Sensitivity of Bioassays

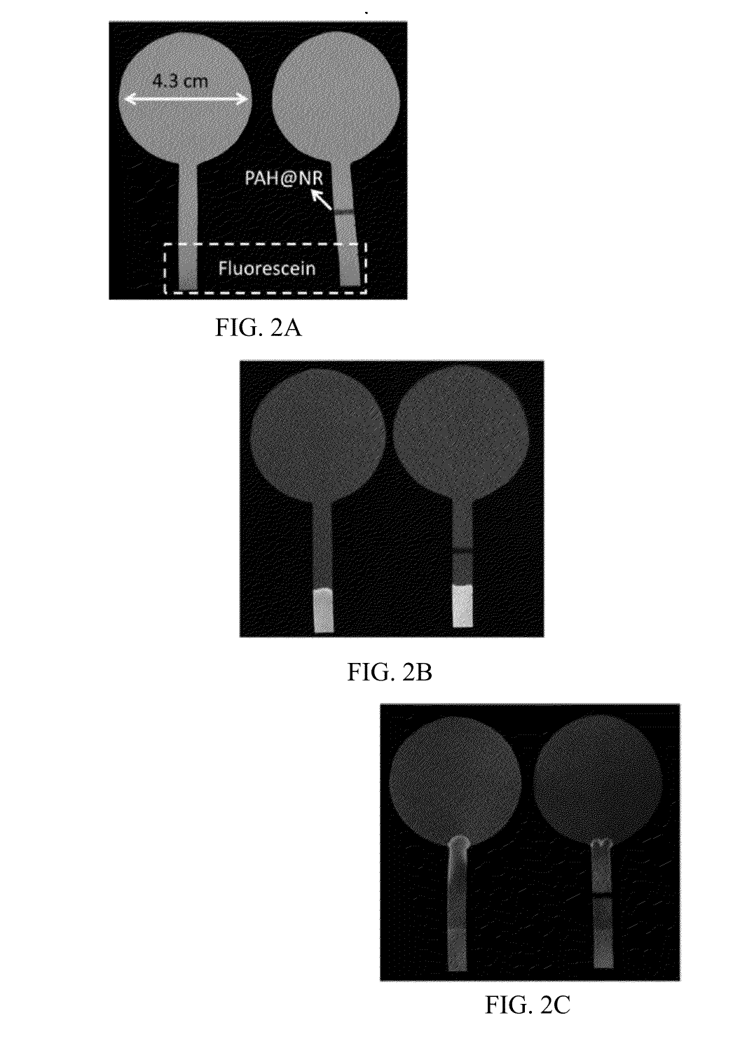

The plasmonic calligraphy approach serves as a simple and powerful tool to miniaturize the test domain size, which leads to dramatic improvement in plasmonic paper-based biosensor performance compared to previous immersion methods. Capillary-driven flow of the analyte solution across the test domain written on paper is employed to maximize the target analyte interaction with the recognition elements on the plasmonic nanostructures. To visually demonstrate the concept of capillary-driven flow-based sensing, AuNRs modified with positively charged poly(allylamine hydrochloride) (PAH@ AuNRs) were written on the stem portion of a paper substrate cut in the shape of a badminton racket with a head of 4.3 cm diameter and a stem of 4×0.6 cm² (FIG. 2A). The head portion serves as a wicking pad or collection reservoir and the bottom end of the stem is immersed in the analyte solution of a predefined volume. The model analyte solution comprised of negatively charged fluorescein molecules was deposited at the lower end of the stem (FIG. 2B). The capillary-driven flow results in the transport of fluorescein from the tip of the stem to the wicking pad. In the case of paper substrate without PAH@AuNRs line, most of the fluorescein is collected at the neck of the substrate as indicated by the strong fluorescence marks on the neck region which is visible under UV illumination (FIG. 2C). On the other hand, reduced fluorescence was observed at the neck region of the substrate with PAH@AuNRs line as most of the negatively charged fluorescein was bound to the positively charged PAH@AuNRs line (FIG. 2C). The absence of strong fluorescence from the PAH@AuNRs line is possibly due to the non-radiative quenching of fluorescence by the plasmonic nanostructures (FIG. 2C).

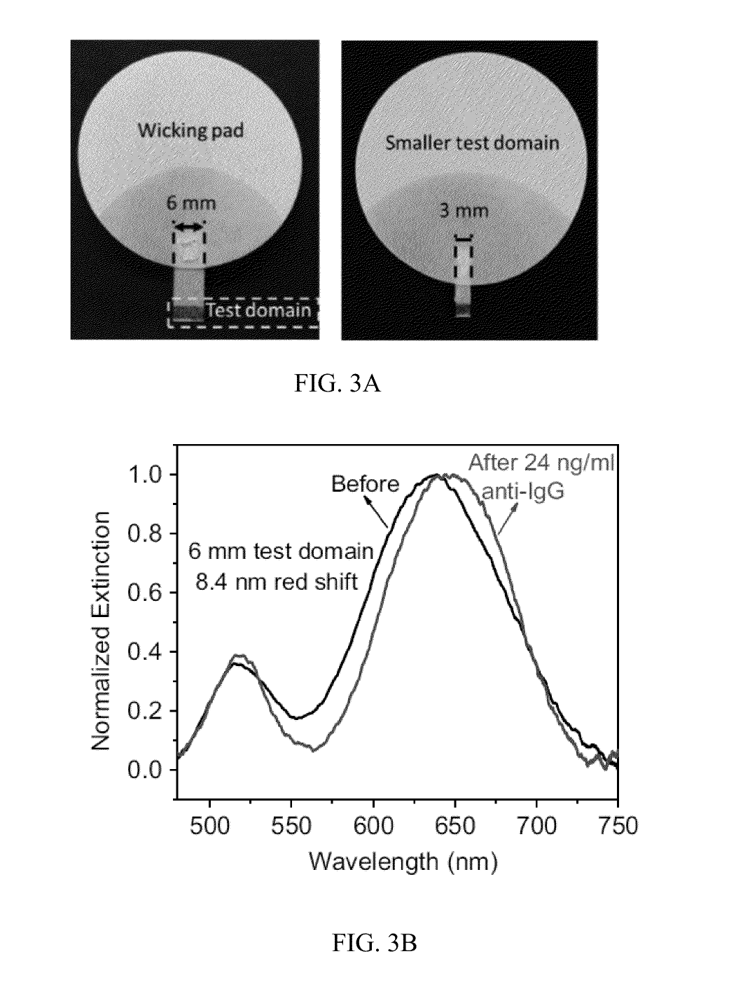

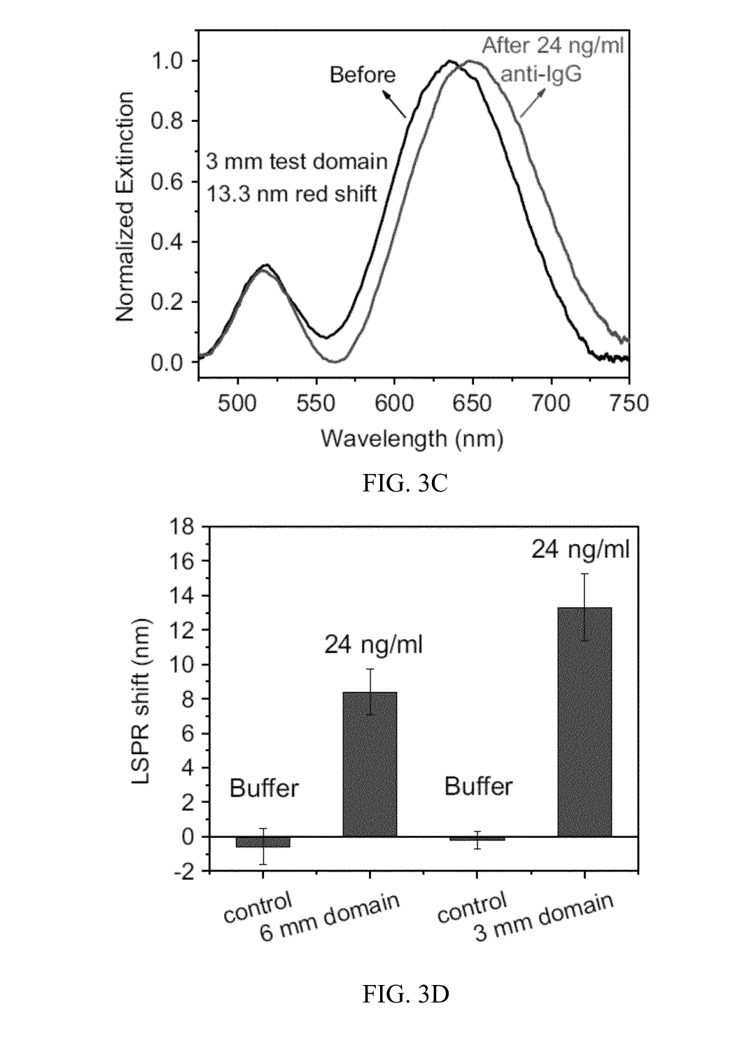

In some sensing systems, miniaturization of the test domain size results in improved sensitivity and lower limit of detection while adversely affecting the dynamic range. In the case of plasmonic sensors, individual nanostructures and even specific parts of individual nanostructures have been employed for chemical and biological detection, which exhibit remarkable sensitivities but limited dynamic range. Some demonstrations involve complex and tedious fabrication methods (e.g., e-beam lithography) and/or signal collection and processing methods (e.g., dark-field scattering spectroscopy). Plasmonic calligraphy approach serves as a facile tool to optimize the test domain size for achieving a balance between sensitivity and dynamic range (e.g., covering physiological and pathological concentration of a protein biomarker). In some embodiments, the test domain size is controlled by cutting the paper substrates to vary the feature size written on the paper substrate using plasmonic ink. FIG. 3A shows a AuNRs line written at the bottom end of the stem portion of a test strip followed by functionalization of AuNR with rabbit immunoglobulin G (IgG). A predefined volume of the target protein solution (100 μl of 24 ng/ml anti-rabbit IgG) was transported from the bottom of the stem to a wicking pad across test domains of different sizes using capillary force. The approach adapted here ensures the analyte to pass through test domain, overcoming one of the drawbacks of miniaturizing the test domain i.e., low probability for the analyte molecules to ‘find and bind’ to the test domain. The LSPR wavelength shift was observed to be 13.3 nm when the domain size was reduced to 3×1.5 mm² compared to 8.4 nm for a test domain of 6×1.5 mm² upon exposure to 24 ng/ml of anti-IgG (FIGS. 3B and 3C). The increase in LSPR shift by about 58%, indicates an improvement in sensitivity by reducing the test domain size (FIG. 3D). Plasmonic calligraphy in combination with ‘paper cutting’ forms a powerful tool to dial in the required sensitivity or dynamic range of a paper-based biosensor.

### III. Multiplexed Biosensing Based on Bioplasmonic Calligraphy

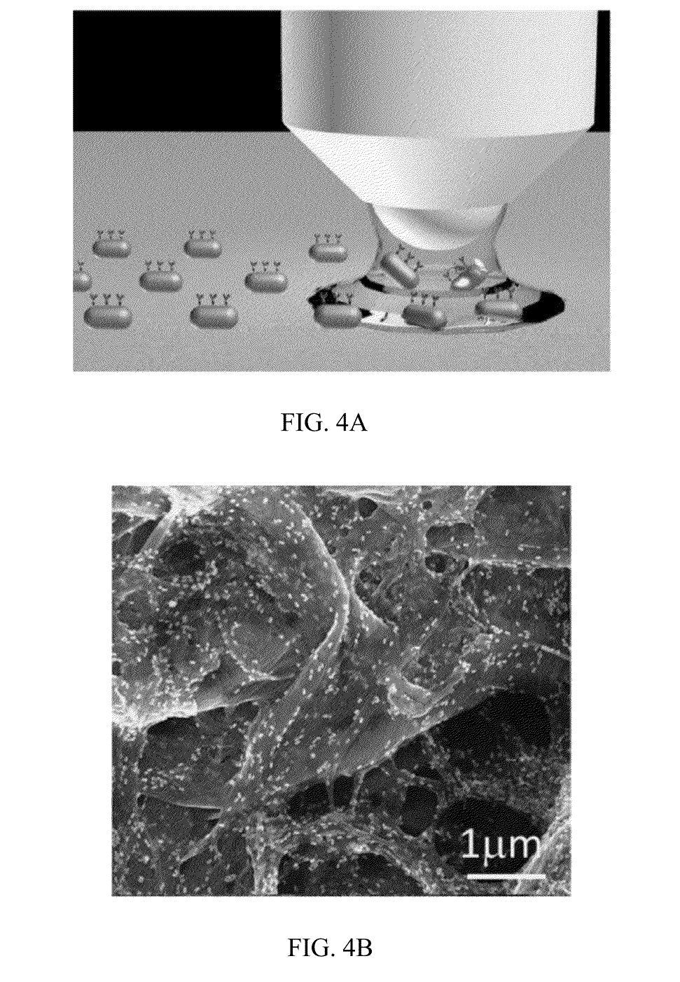

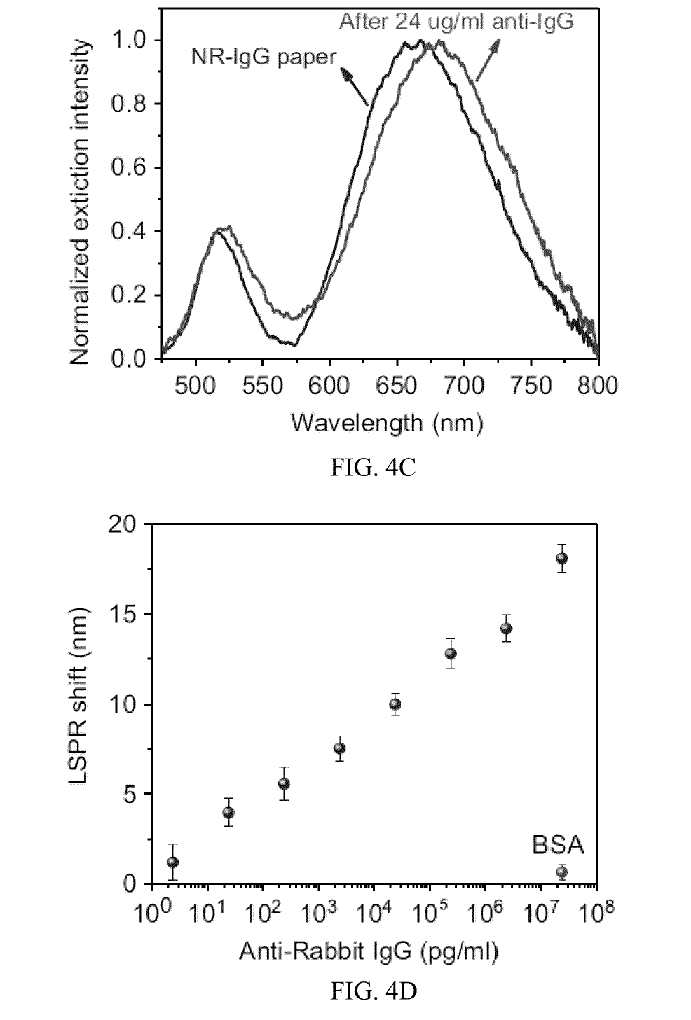

Multi-marker plasmonic biochips using paper substrates that enable multiplexed biosensing are an extremely powerful tool to facilitate the detection and quantification of multiple prognostic biomarkers using the same substrate. To achieve such a multi-marker biochip, in some embodiments, individual test domains are comprised of plasmonic nanostructures with differential functionalization specific to target biomarkers. To realize the differential functionalization of test domains on paper substrates, biofunctionalized nanostructures is used as ink (referred to herein as “plasmonic ink”) rather than biofunctionalization after creating the test domains as described above (FIG. 3A). Such plasmonic ink facilitates writing with distinct biofunctionalized nanostructures on paper substrates adjacent to each other without cross-contaminating the test domains based on the concept of bioplasmonic calligraphy as illustrated in FIG. 4A. SEM images revealed highly uniform distribution of gold nanorods modified with rabbit IgG (NR-rabbit IgG) conjugates on paper surface with no signs of aggregation or patchiness on the substrate (FIG. 4B). Higher magnification image reveals the preferential alignment of AuNRs-rabbit IgG conjugates along the cellulose fibers. Extinction spectra were obtained from paper substrates calligraphed with AuNR-rabbit IgG and subsequently exposed to 24 μg/ml of anti-rabbit IgG (FIG. 4C). LSPR wavelength exhibited a red shift of ˜17 nm upon specific binding of anti-rabbit IgG to rabbit IgG appended on the AuNRs. A semi-log plot of the longitudinal LSPR wavelength shift for different concentrations of anti-rabbit IgG revealed that LSPR shift monotonically increases with increase in the concentration of anti-rabbit IgG. An extremely small LSPR shift (˜1 nm) was noted for relatively high concentration of BSA (24 μg/ml) due to nonspecific binding (FIG. 4D). Detection limit was determined to be 24 pg/ml (˜0.16 pM). The biomolecules appended to the nanostructure preserve their recognition capabilities confirming that the simple bioplasmonic calligraphy approach suggested here is ‘biofriendly’ and can be potentially employed for multiplexed biodetection.

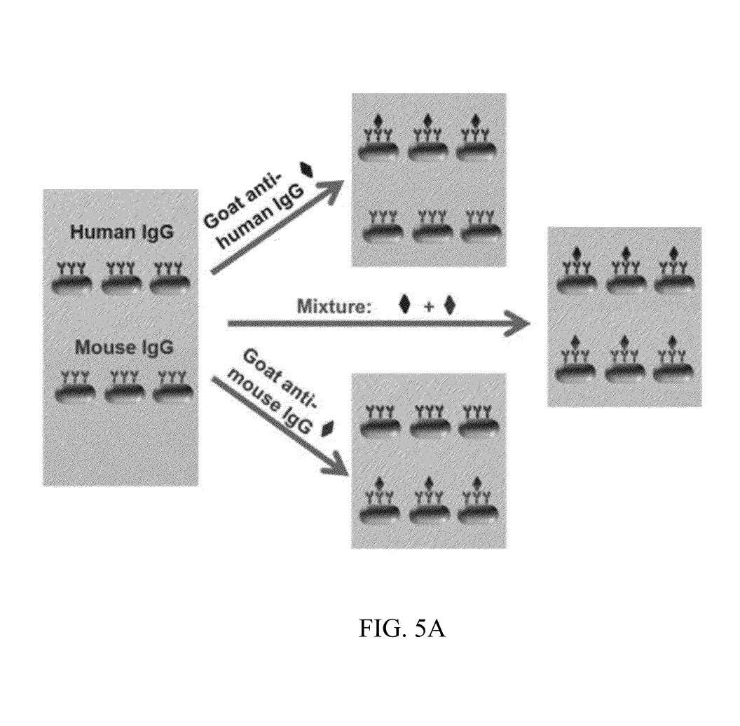

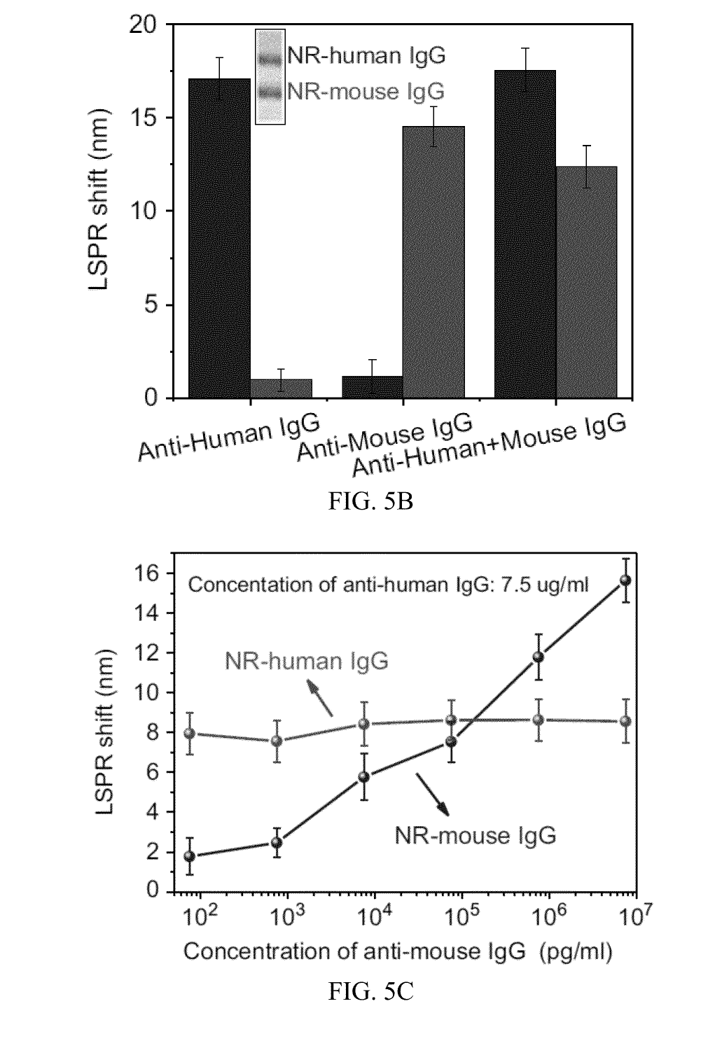

FIG. 5A is an exemplary embodiment of a schematic showing multiplexed detection based on bioplasmonic calligraphy which is used to test capability. Two distinct test domains comprised of AuNRs with human IgG and mouse IgG (FIG. 5A) are used to obtain the LSPR shift upon exposure to the different combination of target proteins (goat anti-human IgG, and goat anti-mouse IgG) (FIG. 5B). Goat anti-human IgG and goat anti-mouse IgG are affinity-purified secondary antibodies with well-characterized specificity for human IgG and mouse IgG, respectively, which were tested by ELISA and/or solid-phase adsorbed to ensure minimal cross-reaction with each other. Extinction spectra of AuNRs functionalized with human IgG (NR-human IgG) showed LSPR shift of ˜17.1 nm and AuNRs functionalized with mouse IgG (NR-mouse IgG) showed extremely small LSPR shift (˜1.0 nm) upon exposure to 24 μg/ml of anti-human IgG (FIG. 5B). On the other hand, upon exposure to 24 ∥g/ml of anti-mouse IgG, NR-human IgG line showed extremely small shift (˜1.1 nm) while LSPR shift of NR-mouse IgG was measured to be ˜14.5 nm (FIG. 5B). Upon exposure to a mixture of anti-human IgG and anti-mouse IgG (24 μg/ml each), NR-human IgG showed ˜17.6 nm of LSPR shift and NR-mouse IgG showed ˜12.3 nm The spectral response of the two lines upon exposure to the mixture closely corresponds to the LSPR shift measured for exposure to individual target biomolecules. This multiplexed bioassay was also challenged with exposure to a mixture of anti-mouse IgG of different concentrations and anti-human IgG of a fixed concentration (FIG. 5C). A monotonic increase in the LSPR shift of NR-mouse IgG band was observed with increasing the concentration of anti-mouse IgG while NR-human IgG band exhibited a stable ˜8 nm LSPR shift corresponding to the fixed concentration of anti-human IgG (7.5 μg/ml) in the mixture. A detection limit of 750 μg/ml of anti-mouse IgG was noted even in the presence of a constant interfering 7.5 mg/ml of anti-human IgG. These results show the capability of multiplexed biosensing based on bioplasmonic calligraphy approach. The approach suggested here obviates the need for any complex multi-step process such as formation of hydrophilic test domains and hydrophobic barriers to achieve label-free multiplexed biodetection.

### IV. Plasmonic Ink

Another aspect of the plasmonic calligraphy is directed to a plasmonic ink (also referred to herein as “bioplasmonic ink” and (bio)plasmonic ink”). The plasmonic ink comprises a biofunctionalized metal nanostructure and a carrier matrix. A basic feature can be that the plasmonic ink includes the carrier matrix and the biofunctionalized metal nanostructure, and is substantially free of components that may interfere with transport of the carrier matrix and the biofunctionalized metal nanostructure.

Suitable biofunctionalized metal nanostructures can be, for example, gold, silver and combinations thereof. The nanostructures can be, for example, nanospheres, nanorods, nanocubes, nanobipyramids, nanostars, nanoshells, hollow nanostructures, and other nano-shapes. Suitable biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof. A particularly suitable biofunctionalized metal nanostructure can be biofunctionalized gold nanorods as described herein.

The carrier matrix of the plasmonic ink can be any solution compatible with the biofunctionalized metal nanostructure. Preferably, the carrier matrix is selected to be such that it does not chemically react with the biofunctionalized metal nanostructure and does not interfere with inherent physical or biological characteristics of the biofunctionalized metal nanostructure. The carrier matrix also should not interfere with the inherent physical or biological characteristics of the substrate (e.g., paper-based substrate) to which the plasmonic ink is applied.

In some aspects, the plasmonic ink includes at least at least 70%, or at least 90% by weight carrier matrix. Particularly suitable carrier matrices can be water, a cetyltrimethylammonium chloride solution, a cetyltrimethylammonium bromide solution, and combinations thereof.

### V. Plasmonic Ink Dispensing Apparatus

In another aspect, the present disclosure is directed to a plasmonic ink dispensing apparatus. The plasmonic ink dispensing apparatus includes a ballpoint pen, wherein the ballpoint pen includes: an ink-accommodation cylinder, a pen tip in which a ball is rotatably held, the pen tip being attached to a tip end of the ink-accommodation cylinder directly or through a tip hold; and a plasmonic ink including a plurality of metal nanostructures and a carrier matrix, the plasmonic ink directly being accommodated in the ink-accommodation cylinder.

Suitable metal nanostructures include biofunctionalized nanostructures. Suitable metals include gold, silver, and combinations thereof.

Particularly suitable the biofunctionalized nanostructures include biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof.

The carrier matrix of the plasmonic ink can be any solution compatible with the metal nanostructures. Preferably, the carrier matrix is selected to be such that it does not chemically react with metal nanostructures and biofunctionalized metal nanostructures and does not interfere with inherent physical or biological characteristics of the metal nanostructures and biofunctionalized metal nanostructures. The carrier matrix also should not interfere with the inherent physical or biological characteristics of the substrate (e.g., paper-based substrate) to which the plasmonic ink is applied. Particularly suitable the carrier matrices include water, a cetyltrimethylammonium chloride solution, a cetyltrimethylammonium bromide solution, and combinations thereof.

### EXAMPLE

Materials

Cetyltrimethylammonium bromide (CTAB), chloroauric acid, ascorbic acid, sodium borohydride, poly(styrene sulfonate) (PSS) (Mw=70,000 g/mol), and poly(allyl amine hydrochloride) (PAH) (Mw=56,000 g/mol). Silver nitrate and filter paper (Whatman #1). 1-Ethyl-3-(3-dimethylaminopropyl) carbodiimide (EDC) and N-hydroxy succinimide (NHS), Rabbit IgG, Goat anti-Rabbit IgG, Human IgG, Goat anti-human IgG, Mouse IgG, and Goat anti-mouse IgG. SH-PEG-COOH (Mw=5000 g/mol). All the chemicals have been used as received with no further purification. Paper mate profile retractable ballpoint pens are the type of pens used.

Synthesis of Gold Nanorods (AuNRs)

Gold nanorods were synthesized using a seed-mediated approach. Seed solution was prepared by adding 0.6 ml of an ice-cold sodium borohydride solution (10 mM) into 10 ml of 0.1 M cetyltrimethylammonium bromide (CTAB) and 2.5×10⁻⁴ M chloroauric acid (HAuCl₄) solution under vigorous stirring at room temperature. The color of the seed solution changed from yellow to brown. Growth solution was prepared by mixing 95 ml of CTAB (0.1 M), 0.5 ml of silver nitrate (10 mM), 4.5 ml of HAuCl₄ (10 mM), and 0.55 ml of ascorbic acid (0.1 M) consecutively. The solution was homogenized by gentle stirring. To the resulting colorless solution, 0.12 ml of freshly prepared seed solution was added and set aside in the dark for 14 h. Prior to use, the AuNRs solution was centrifuged twice at 10,000 rpm for 10 min to remove excess CTAB and redispersed in nanopure water (18.2 MSΩcm).

Preparation of Polyelectrolytes Coated Gold Nanorods (AuNRs)

AuNRs were modified with polyelectrolytes as described below. Briefly, 1 ml of twice centrifuged AuNRs solution was added drop-wise to 0.5 ml of PSS solution (0.2%, w/v) in 6 mM NaCl aqueous solution under vigorous stirring, and left undisturbed for 3 h. To remove excess PSS, the above solution was centrifuged at 10,000 rpm for 10 min, and the pellet was dispersed in nanopure water after removing the supernatant. To modify AuNRs with PAH, 1 ml of PSS coated AuNRs solution was added drop-wise to 0.5 ml of PAH (0.2%, w/v) solution in 6 mM NaCl, stirred for 3 h. The resultant 1 ml of PAH coated AuNRs solution was centrifuged and concentrated to 10 ml and employed as ink to write on paper substrates. The surface charge of CTAB stabilized AuNRs, PSS and PAH coated AuNRs were estimated by measuring the zeta potential of corresponding solution.

AuNRs-IgG Conjugates Preparation

To a 37.5 μl solution pf heterobifunctional polyethylene glycol (SH-PEG-COOH) in water (20 μM, Mw=5000 g/mol), EDC and NHS with the same molar ratio as SH-PEG-Cooh were added followed by shaking for 1 h. The pH of the above reaction mixture was adjusted to 7.4 by adding 10× concentrated phosphate buffered saline (PBS), followed by the addition of 10 pl of rabbit immunoglobulin G (IgG) solution (75 μM, Mw=150 kDa). The reaction mixture was incubated for an additional 2 h, and then filtered to remove any byproduct during the reaction by centrifugation using a centrifuge tube with 50 kDa filter. The final SH-PEG-IgG conjugates solution (0.75 μM) was obtained after washing with PBS buffer (pH 7.4) twice. AuNRs-IgG conjugates' solution was prepared by adding 50 ml of SH-PEG-IgG conjugates solution to 1 ml of twice centrifuged AuNRs solution with incubation for 1 h. The amount of SH-PEG-IgG was optimized to obtain maximum coverage of IgG on AuNRs surface. Using SDS-PAGE, the affinity of SH-PEG-IgG remains essentially the same as that of pristine IgG.

Bioplasmonic Paper Substrates Preparation

A regular laboratory filter paper (WHATMAN® #1) was immersed into a 1% (w/v) BSA in PBS buffer (pH 7.5) for 1 h as a pretreatment step to prevent nonspecific binding. It is noted ˜30% improvement in plasmonic biosensor response (i.e., longitudinal LSPR shift of AuNRs) for BSA-blocked paper compared to pristine paper. Plasmonic ink was prepared by concentrating 1 ml of twice centrifuged as synthesized AuNRs to 10 ml after centrifugation. Plasmonic ink was concentrated from 1 ml of NR-IgG conjugates solution by centrifugation at 3000 rpm for 20 min. The plasmonic ink was injected into an empty ballpoint pen refill cleaned with ethanol and nanopure water by sonication. The adsorption of AuNRs-IgG conjugates on paper was achieved by direct writing with plasmonic ink filled pen, or exposing written AuNRs paper in SH-PEG-IgG conjugates solution for 30 min, followed by thorough rinsing with buffer and nanopure water. The paper was exposed to various concentrations of anti-IgG in PBS for 1 h, followed by thorough rinsing with PBS and water and drying with a stream of nitrogen.

Extinction Spectra Measurements

Extinction spectra from paper substrates were collected using a CRAIC microspectrophotometer (QDI 302) coupled to a Leica optical microscope (DM 4000 M) with 20× objective in the range of 450-800 nm with 10 accumulations and 0.1 s exposure time in reflection mode. The spectral resolution of the spectrophotometer is 0.2 nm Several UV-vis extinction spectra (-10) were collected for each substrate before and after anti-IgG exposure. Each spectrum represented a different spot within the same substrate. Shimadzu UV-1800 spectrophotometer was employed for collecting UV-vis extinction spectra from solution.

Characterization

Transmission electron microscopy (TEM) micrographs were recorded on a JEM-2100F (JEOL) field emission instrument. Samples were prepared by drying a drop of the solution on a carbon-coated grid, which had been previously made hydrophilic by glow discharge. Scanning electron microscope (SEM) images were obtained using a FEI Nova 2300 Field Emission SEM at an accelerating voltage of 10 kV. Plasmonic paper was gold sputtered for 60 s before SEM imaging.

This example demonstrates plasmonic calligraphy approach for realizing multiplexed label-free bioassays using a regular ballpoint pen filled with gold nanorods or biofunctionalized gold nanorods as (bio)plasmonic ink.

Plasmonic calligraphy approach serves as a simple and powerful tool to miniaturize test domain size by controlling the calligraphed feature size and simply cutting the paper to desired dimensions, which results in dramatic improvement in sensitivity and lowering limit of detection. The present disclosure introduced a low-cost novel approach for fabricating multiplexed label-free biosensing on paper substrates in the form of bioplasmonic calligraphy. The calligraphy approach allows one of ordinary skill in the art to create well-isolated test domains on paper substrates using biofunctionalized plasmonic nanostructures as ink. This example demonstrated the feasibility of such an approach for multiplexed biosensing using two target proteins. Bioplasmonic calligraphy can serve as a powerful tool enabling the synergism of paper-based microfluidics and plasmonic biosensing.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the scope and concept of the disclosure as defined by the appended claims.

What is claimed is:

1. A method of preparing a label-free biosensing substrate, the method comprising:
providing a plasmonic ink dispensing apparatus, wherein the plasmonic ink dispensing apparatus comprises
a plasmonic ink, the plasmonic ink comprising a plurality of metal nanostructures and a carrier matrix; and
depositing the plasmonic ink on a substrate to produce a pattern on the substrate.

2. The method of claim 1, wherein the plurality of metal nanostructures comprises a plurality of biofunctionalized nanostructures.

3. The method of claim 2, wherein the plurality of biofunctionalized nanostructures are selected from the group consisting of biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof.

4. The method of claim 1, wherein the plurality of metal nanostructures comprises a binding domain that specifically binds to a target biomolecule.

5. The method of claim 1, wherein the substrate is selected from the group consisting of a paper substrate, a cellulose substrate, and a nylon substrate.

6. The method of claim 1, wherein the plasmonic ink dispensing apparatus comprises a ballpoint pen.

7. The method of claim 1, further comprising providing at least a second plasmonic ink dispensing apparatus, the second plasmonic ink dispensing apparatus comprising
a second plasmonic ink, the second plasmonic ink comprising a plurality of second metal nanostructures and a carrier matrix; and
depositing the second plasmonic ink on the substrate to produce a second pattern on the substrate.

8. The method of claim 7, wherein the plurality of second metal nanostructures comprises a plurality of second biofunctionalized nanostructures.

9. The method of claim 8, wherein the plurality of second biofunctionalized nanostructures are selected from the group consisting of biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof.

10. The method of claim 1, wherein the plurality of second metal nanostructures comprises a binding domain that specifically binds to at least a second target biomolecule.

11. The method of claim 1, wherein deposition of the plasmonic ink is by manual deposition of the plasmonic ink.

12. The method of claim 1, wherein deposition of the plasmonic ink is by automated deposition of the plasmonic ink.

13. A plasmonic ink comprising: a plurality of metal nanostructures and a carrier matrix.

14. The plasmonic ink of claim 13, wherein the plurality of metal nanostructures comprises a binding domain that specifically binds to a target biomolecule.

15. The plasmonic ink of claim 13, wherein the metal nanostructures are biofunctionalized nanostructures.

16. The plasmonic ink of claim 15, wherein the metal nanostructures are selected from the group consisting of biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof.

17. The plasmonic ink of claim 13, wherein the carrier matrix is selected from the group consisting of water, a cetyltrimethylammonium chloride solution, a cetyltrimethylammonium bromide solution, and combinations thereof.

18. A plasmonic ink dispensing apparatus comprising: a ballpoint pen comprising: an ink-accommodation cylinder; a pen tip in which a ball is rotatably held, the pen tip being attached to a tip end of an ink-accommodation cylinder directly or through a tip holder; and a plasmonic ink comprising a plurality of metal nanostructures and a carrier matrix, the plasmonic ink directly being accommodated in the ink-accommodation cylinder.

19. The plasmonic ink dispensing apparatus of claim 18, wherein the plurality of metal nanostructures are biofunctionalized nanostructures.

20. The plasmonic ink dispensing apparatus of claim 18, wherein the biofunctionalized nanostructures are selected from the group consisting of biofunctionalized metal nanorods, biofunctionalized metal nanospheres, biofunctionalized metal nanoshells, biofunctionalized metal nanocubes, biofunctionalized metal nanobipyramids, biofunctionalized metal nanostars, biofunctionalized metal hollow nanostructures, and combinations thereof.
